(19) United States
(12) Patent Application Publication
(10) Pub. No.: US 2012/0162074 A1
(43) Pub. Date: Jun. 28, 2012

(54) USER INTERFACE APPARATUS AND METHOD USING TWO-DIMENSIONAL IMAGE SENSOR

(75) Inventors: Joo Young HA, Suwon (KR); Sun Mi SIN, Suwon (KR); Ho Seop JEONG, Seongnam (KR); In Cheol CHANG, Seongnam (KR); Byung Hoon KIM, Suwon (KR)

(73) Assignee: SAMSUNG ELECTRO-MECHANICS CO., LTD., Suwon (KR)

(21) Appl. No.: 13/332,615

(22) Filed: Dec. 21, 2011

(30) Foreign Application Priority Data
Dec. 24, 2010 (KR) 10-2010-0134518

(51) Int. Cl. G09G 5/08

(52) U.S. Cl. 345/158

(57) ABSTRACT

There are provided a user interface apparatus and method using a two-dimensional (2D) image sensor capable of setting an object for an interface from a user image detected by the 2D image sensor and performing a user input accordingly. The user interface apparatus includes: a two-dimensional (2D) image sensor; and a user interface unit detecting a movement of a user captured by the 2D image sensor, setting the detected movement as an object, and outputting the movement of the object detected by the 2D image sensor to a system in which the user intends to establish an interface.

### CROSS-REFERENCE TO RELATED APPLICATIONS

This application claims the priority of Korean Patent Application No. 10-2010-0134518 filed on Dec. 24, 2010, in the Korean Intellectual Property Office, the disclosure of which is incorporated herein by reference.

### BACKGROUND OF THE INVENTION

1. Field of the Invention

The present invention relates to a user interface apparatus and method, and more particularly, to a user interface apparatus and method using a two-dimensional (2D) image sensor capable of setting an object for an interface from a user image detected by the 2D image sensor and performing a user input accordingly.

2. Description of the Related Art

A user interface (UI) refers to a command or a technique used for general users to control a data input or an operation in a computer system or a program. An ultimate purpose of a UI is to allow users to communicate with a computer or a program to easily and conveniently use the computer or the program.

The related art computer has been designed to focus on improvements in the efficiency or rate of computation or calculation. The related art computer has been designed based upon a premise that a user knows all about a computer regarding connections between the user and the computer.

However, currently, computers are not exclusively used by some experts who know all about the computers, and not a machine which simply performs a calculation function but is increasingly utilized as a tool for upgrading users' creativity. Thus, currently, UIs in computers have been developed as tools for taking the user convenience of non-experts into consideration and improving the performance of an overall system.

### SUMMARY OF THE INVENTION

An aspect of the present invention provides a user interface apparatus and method capable of providing a more practical, convenient user interface to users by using an image obtained by a two-dimensional (2D) image sensor which is currently prevalent.

According to an aspect of the present invention, there is provided a user interface apparatus including: a two-dimensional (2D) image sensor; and a user interface unit detecting a movement of a user captured by the 2D image sensor, setting the detected movement as an object, and outputting the movement of the object detected by the 2D image sensor to a system in which the user intends to establish an interface.

The user interface unit may include an interrupt determining part determining a type of user interrupt; an object setting part setting a particular area of an input image as an object and storing corresponding content, when the user interrupt is determined for setting a new object; and an object recognizing part recognizing the object from the input image based on information of the object previously set and stored, determining a command desired to be performed by the object, and outputting a user interface command signal.

The object setting part may feed back the setting of the new object to the user.

The object recognizing part may recognize the object from the input image in consideration of shape, size, texture, and color of the object previously stored.

When the movement of the object is repeated in two opposite directions, the object recognizing part may determine that one of the directions is valid.

The object recognizing part may display an image displaying a certain function performed by a user interface on a display unit, and form a user interface according to a relationship between the image displaying the certain function and a cursor by using a position of the recognized object as the cursor.

According to another aspect of the present invention, there is provided a user interface method including: determining a type of user interrupt; capturing a user image, and setting a new object from the captured user image when the user interrupt is determined for inputting the new object; and recognizing an object from an input image by using a previously stored object feature, and performing a user interface operation according to a movement of the recognized object when the user interrupt is determined for recognizing the object.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram showing an example of a system employing a user interface apparatus according to an embodiment of the present invention;

FIG. 2 is a detailed block diagram of a user interface apparatus according to an embodiment of the present invention;

FIG. 3 is a flowchart illustrating a user interface method according to an embodiment of the present invention;

FIG. 4 is a view illustrating a system for the realization of a user interface apparatus and method according to an embodiment of the present invention;

FIG. 5A and 5B are views showing a concept of setting an object used in a user interface in the system illustrated in FIG. 4;

FIGS. 6A and 6B are views showing an example of changing the shape of an object in a user interface apparatus and method according to an embodiment of the present invention;

FIGS. 7A and 7B are views explaining a method for recognizing a movement of an object in a process of performing a user interface in a user interface apparatus and method according to an embodiment of the present invention; and

FIGS. 8A and 8B are views showing an application example of a user interface apparatus and method according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of components may be exaggerated for clarity, and the same reference numerals will be used throughout to designate the same or like components.

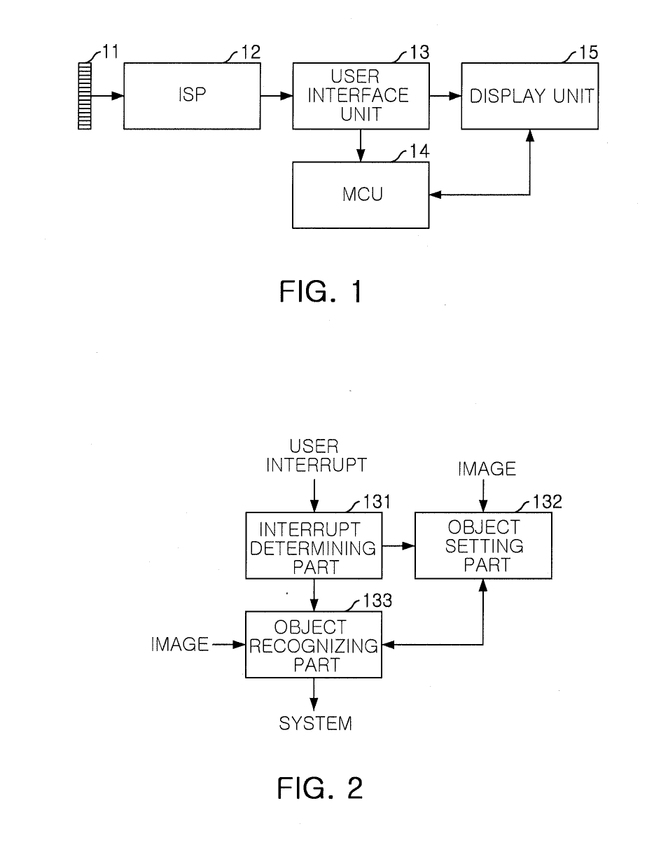

FIG. 1 is a schematic block diagram showing an example of a system employing a user interface apparatus according to an embodiment of the present invention.

As shown in FIG. 1, a system employing a user interface apparatus according to an embodiment of the present invention may include a two-dimensional (2D) image sensor 11, an image signal processor (ISP) 12, a user interface unit 13, a microcontroller unit (MCU) (or a system control unit) 14, and a display unit 15.

In the embodiment of the present invention, the user interface unit 13 may receive a user command by using a user image detected by the 2D image sensor 11. Image processing is performed by the ISP 12 on signals denoting the user image detected by the 2D image sensor 11. Through the image processing, color, chroma, brightness, and the like, of the user image signals are adjusted to enhance image quality.

The user interface unit 13 may recognize an object area indicating the user command from the input user image, interpret a command indicated by the object area, and transfer a signal corresponding thereto to the MCU 14 and the display unit 15.

FIG. 2 is a detailed block diagram of a user interface apparatus according to an embodiment of the present invention.

With reference to FIG. 2, the user interface unit 13 according to an embodiment of the present invention may include an interrupt determining part 131, an object setting part 132, and an object recognizing part 133.

The interrupt determining part 131 may determine a type of user interrupt to determine whether to set a new object on the input image or whether to recognize a pre-set object from the input image.

When the user interrupt is determined as an interrupt for setting a new object, the object setting part 132 may set a particular area (e.g., hand, mobile phone, etc.) in the input image, as an object, and store corresponding content.

The object recognizing part 133, provided to recognize a pre-set object, may recognize an object from the input image based on information of the object previously set and stored, determine a command desired to be performed by the object, and output a user interface command signal.

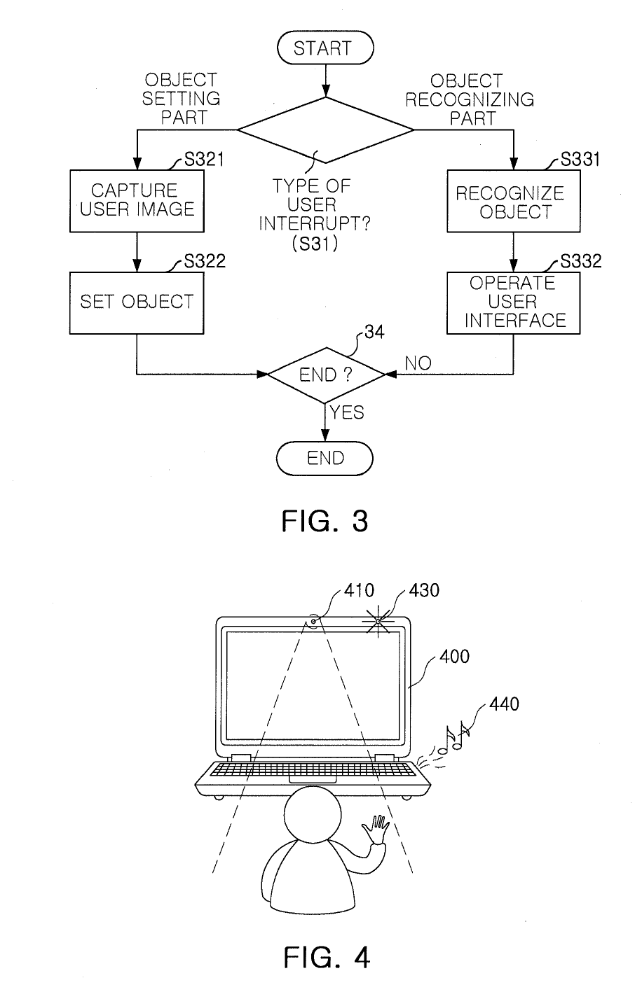

FIG. 3 is a flowchart illustrating a user interface method according to an embodiment of the present invention.

As shown in FIG. 3, according to the user interface method according to the embodiment of the present invention, first, a type of user interrupt is determined (S31).

When the user interrupt is determined for inputting an object, a user image is captured (S321), and an object is set from the captured image (S322).

When the user interface operation is not terminated (S34), the process may be returned to the operation (S31) for determining a type of user interrupt.

Meanwhile, when the user interrupt is determined for recognizing an object, an object is recognized from an input image by using a pre-set object feature (S331), and the user interface operation may be performed according to a movement of the recognized object (S332).

FIG. 4 is a view illustrating a system for the realization of a user interface apparatus and method according to an embodiment of the present invention.

As shown in FIG. 4, the system in which the user interface apparatus and method according to the embodiment of the present invention is implemented may be a personal computer system such as a notebook computer 400 including a 2D image sensor 410. The notebook computer 400 may include a lighting system 430 and/or a sound system 440 for feeding back as to whether or not a user interface operation is performed.

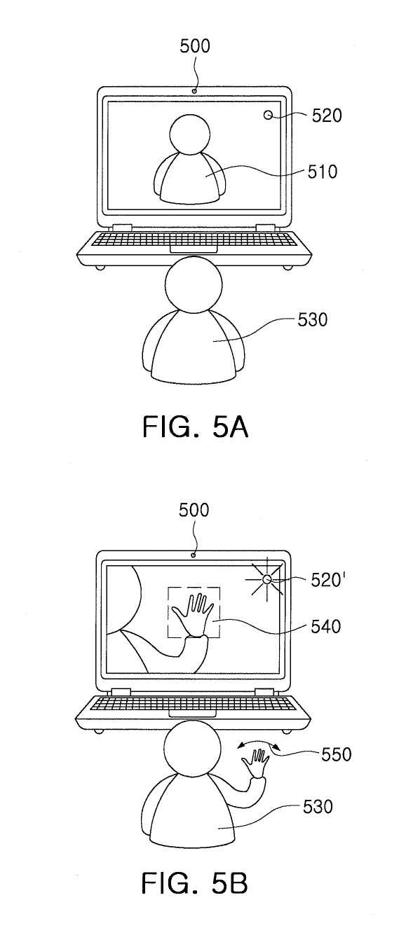

FIGS. 5A and 5B are views showing a concept of setting an object used in a user interface in the system illustrated in FIG. 4. Namely, FIGS. 5A and 5B explain the operation of the object setting part 132 illustrated in FIG. 2 in more detail, as well as explaining the user image capturing operation (S321) and the object setting operation (S322) illustrated in FIG. 3 in more detail.

As shown in FIG. 5A, an image of a user 530 may be captured (510) by using a 2D image sensor provided in a notebook computer 500, and when setting an object is to be undertaken, the captured image may be fed back to the user 530 by using a display area 520 within a display unit.

Subsequently, as shown in FIG. 5B, a portion of the image to be used as the object of the user interface is moved (550) to allow the system to recognize the object 540. Here, similar to FIG. 5A, information indicating that the object recognition is being performed and information indicating that the object recognition has been completed may be displayed by using a display area 520′ within the display unit.

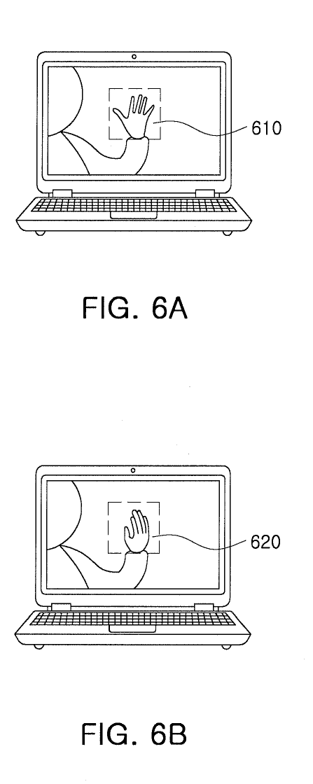

FIGS. 6A and 6B are views showing an example of changing the shape of an object in a user interface apparatus and method according to an embodiment of the present invention;

As shown in FIGS. 6A and 6B, the object may not always have a constant shape. An object 610 illustrated in FIG. 6A and an object 620 illustrated in FIG. 6B are identically set as a hand, but the shapes thereof may be changed according to a movement of the hand or an image capture direction thereof.

Thus, in order to recognize the object even when the shape of the object is partially changed, the color, size, and texture of the object, as well as the shape and outline of the object, may be used for recognizing the object.

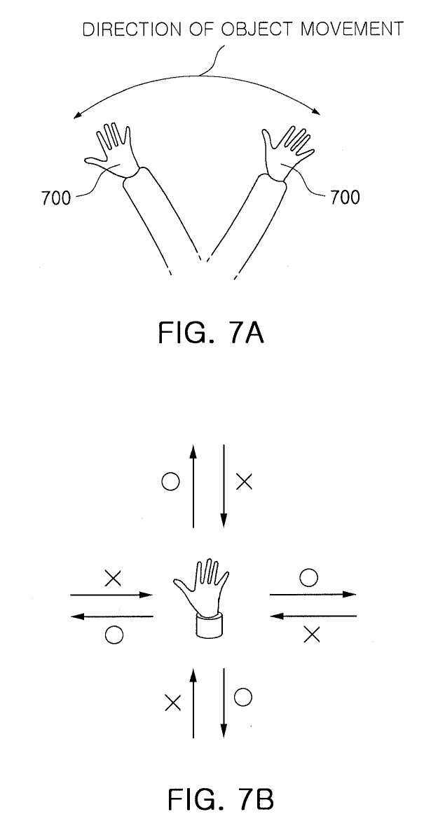

FIG. 7 is a view explaining a method for recognizing a movement of an object in a process of performing a user interface in a user interface apparatus and method according to an embodiment of the present invention.

FIG. 7A shows a case in which the user repeatedly moves an object 700 left and right for a user interface. In this case, when the system separately reacts to a case in which the object is moved to the right and to a case in which the object is moved to the left, a user interface cannot be properly performed. Accordingly, the movement in one direction may be recognized, while the movement in the other direction may not be recognized but disregarded.

As shown in FIG. 7B, when the object 700 is moved in both directions on the substantially same path, only the movement in an outward direction from a recognized position may be recognized, while the movement in the opposite direction may be disregarded. Alternatively, conversely, only the movement in an inward direction may be recognized, while the movement in the opposite direction may be disregarded.

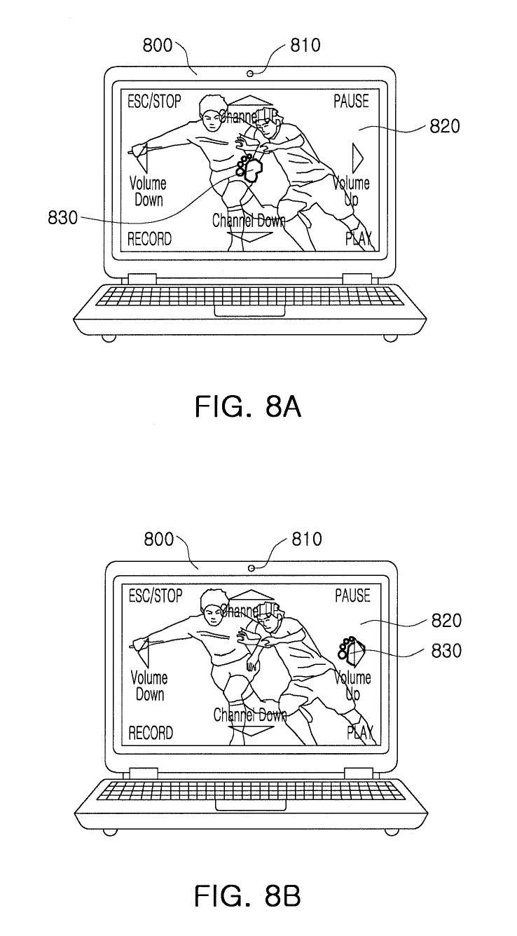

FIGS. 8A and 8B are views showing an application example of a user interface apparatus and method according to an embodiment of the present invention.

As shown in FIG. 8A, images 830 displaying particular functions may be displayed on a display unit of a system (notebook computer) 800. For example, the images 830 may display functions of raising or lowering the volume or changing channels. A certain image 820 serving as a cursor may be displayed at the center of the display unit. The image 820 serving as the cursor may reflect a movement of an object determined according to the recognition of the object.

As shown in FIG. 8B, when the image 820 serving as the cursor is moved to overlap with the image 830 corresponding to a particular function according to the movement of the object, the particular function designated for the image 830 may be performed. For example, when an image indicating a volume up function and an image moved by the movement of the object overlap with each other, the function of raising the volume of the system may be performed.

As set forth above, according to embodiments of the invention, a movement of a user can be recognized by using the 2D image sensor, whereby the system can be stably controlled.

In addition, since the reaction of the system according to a movement of the user can be recognized in real time, a smooth interface can be obtained between the user and the system.

While the present invention has been shown and described in connection with the embodiments, it will be apparent to those skilled in the art that modifications and variations can be made without departing from the spirit and scope of the invention as defined by the appended claims.

What is claimed is:

1. A user interface apparatus comprising:
a two-dimensional (2D) image sensor; and
a user interface unit detecting a movement of a user captured by the 2D image sensor, setting the detected movement as an object, and outputting the movement of the object detected by the 2D image sensor to a system in which the user intends to establish an interface.

2. The user interface apparatus of claim 1, wherein the user interface unit includes:
an interrupt determining part determining a type of user interrupt;
an object setting part setting a particular area of an input image as an object and storing corresponding content, when the user interrupt is determined for setting a new object; and
an object recognizing part recognizing the object from the input image based on information of the object previously set and stored, determining a command desired to be performed by the object, and outputting a user interface command signal.

3. The user interface apparatus of claim 2, wherein the object setting part feeds back the setting of the new object to the user.

4. The user interface apparatus of claim 2, wherein the object recognizing part recognizes the object from the input image in consideration of shape, size, texture, and color of the object previously stored.

5. The user interface apparatus of claim 2, wherein, when the movement of the object is repeated in two opposite directions, the object recognizing part determines that one of the directions is valid.

6. The user interface apparatus of claim 2, wherein the object recognizing part displays an image displaying a certain function performed by a user interface on a display unit, and forms a user interface according to a relationship between the image displaying the certain function and a cursor by using a position of the recognized object as the cursor.

7. A user interface method comprising:
determining a type of user interrupt;
capturing a user image, and setting a new object from the captured user image when the user interrupt is determined for inputting the new object; and
recognizing an object from an input image by using a previously stored object feature, and performing a user interface operation according to a movement of the recognized object when the user interrupt is determined for recognizing the object.

8. The user interface method of claim 7, wherein, the setting of the new object is fed back to the user.

9. The user interface method of claim 7, wherein the performing of the user interface operation includes recognizing the object from the input image in consideration of shape, size, texture, and color of the object previously stored.

10. The user interface method of claim 7, wherein, in the performing of the user interface operation, when the movement of the object is repeated in two opposite directions, it is determined that one of the directions is valid.

11. The user interface method of claim 6, wherein, in the performing of the user interface operation, an image displaying a certain function performed by a user interface is displayed on a display, and a user interface is formed according to a relationship between the image displaying the certain function and a cursor by using a position of the recognized object as the cursor.
